(19) United States
(12) Patent Application Publication
(10) Pub. No.: US 2021/0218825 A1
(43) Pub. Date: Jul. 15, 2021

(54) METHOD AND SYSTEM FOR OPTIMIZING OVER THE AIR DELIVERY BY UTILIZING A COMBINATION OF STATIC AND DYNAMIC INFORMATION

(71) Applicant: Aeris Communications, Inc., San Jose, CA (US)

(72) Inventors: Narendra SHARMA, Sunnyvale, CA (US); Amit KHETAWAT, San Jose, CA (US); David HU, Sunnyvale, CA (US); Anand Vivek KHANDURI, Sunnyvale, CA (US); Eran NETANEL, Belmont, CA (US); Yevgeny KHESSIN, Ann Arbor, MI (US)

(21) Appl. No.: 17/148,294

(22) Filed: Jan. 13, 2021

Related U.S. Application Data
(60) Provisional application No. 62/960,770, filed on Jan. 14, 2020.

(51) Int. Cl. H04L 29/08; H04L 12/26; G06F 8/65; G06N 20/00

(52) U.S. Cl. CPC H04L 67/322; H04L 67/18; H04L 67/104; G06N 20/00; H04L 43/0817; H04L 43/0882; G06F 8/65; H04L 67/141

(57) ABSTRACT

A computer-implemented system and method for Over The Air delivery of firmware to devices enabled for connectivity using static and dynamic information about the devices are disclosed. The computer-implemented method for Over The Air delivery of firmware to devices enabled for connectivity using static and dynamic information about the devices comprises receiving static device information for the one or more devices; receiving dynamic device information for the one or more devices; dynamically grouping the one or more devices based on the static device information, the dynamic device information or the combination thereof; and dynamically scheduling Over The Air delivery of firmware using the grouping to the one or more devices enabled for connectivity.

### CROSS-REFERENCE TO RELATED APPLICATIONS

Under 35 USC 119(e), this application claims priority to U.S. provisional application Ser. No. 62/960,770, entitled “METHOD AND SYSTEM FOR OVER THE AIR DELIVERY OF FIRMWARE USING CONNECTIVITY STATUS”, filed on Jan. 14, 2020, all of which is herein incorporated by reference in its entirety.

### FIELD OF THE INVENTION

The present invention relates generally to optimization of over the air delivery of firmware to devices containing a product that enables connectivity for M2M or Internet of Things (IoT) devices using static as well as dynamic information about the devices.

### BACKGROUND

Devices, whether phones, radios or other types of hardware, known as M2M or Internet of Things (IoT) devices, that are intended to connect to networks, such as wireless or cellular networks, are enabled to connect to networks, such as by use with products such as Subscriber Identification Modules (SIMs). As IoT solutions are being deployed in high volume, the need and demand for the IoT devices to support efficient and scalable Over The Air (OTA) delivery of firmware is becoming stronger. In most cases, device companies that started with homegrown OTA solutions as an afterthought are encountering scalability and efficiency problems.

Accordingly, what are needed are system and method to address the above identified issues. The present invention addresses such a need.

### SUMMARY

A computer-implemented system and method for optimizing Over The Air delivery of firmware to devices enabled for connectivity using static and dynamic information about the devices are disclosed. The computer-implemented method for optimizing Over The Air delivery of firmware to devices enabled for connectivity using static and dynamic device information about the devices comprises receiving static device information for the one or more devices; receiving dynamic device information for the one or more devices; dynamically grouping the one or more devices based on the static device information, the dynamic device information or the combination thereof; and dynamically scheduling Over The Air delivery of firmware using the grouping to the one or more devices enabled for connectivity.

The system for optimizing Over The Air delivery of firmware to devices enabled for connectivity using static and dynamic information about the devices comprises one or more devices enabled for connectivity; an IoT platform for establishing an inventory of devices enabled for connectivity; an OTA platform configured to: receive static device information for the one or more devices; receive dynamic device information for the one or more devices; dynamically group the one or more devices based on the static device information, the dynamic device information or the combination thereof; and dynamically schedule Over The Air delivery of firmware using the grouping to the one or more devices enabled for connectivity.

In an embodiment, a computer program product for optimizing Over The Air delivery of firmware to devices enabled for connectivity using static and dynamic information about the devices is also disclosed. The computer program product stored on a non-transferable computer readable medium for optimizing Over The Air delivery of firmware to devices enabled for connectivity using static and dynamic information about the devices, comprising computer readable instructions for causing a computer to control an execution of an application for optimizing Over The Air delivery of firmware to one or more devices enabled for connectivity comprising receiving static device information for the one or more devices; receiving dynamic device information for the one or more devices; dynamically grouping the one or more devices based on the static device information, the dynamic device information or the combination thereof; and dynamically scheduling Over The Air delivery of firmware using the grouping to the one or more devices enabled for connectivity.

In an embodiment, the method and system for optimizing Over The Air delivery of firmware to devices enabled for connectivity using static and dynamic information about the devices may further include receiving network status information and dynamically grouping the one or more devices based on the static device information, the dynamic device information and network status information.

In an embodiment, the method and system for optimizing Over The Air delivery of firmware to devices enabled for connectivity using static and dynamic information about the devices may be enhanced by using an agent. In an embodiment, the method and system for Over The Air delivery of firmware to devices enabled for connectivity using static and dynamic information about the devices may be agentless.

In an embodiment, the method and system for optimizing Over The Air delivery of firmware to devices enabled for connectivity using static and dynamic information about the devices may include Over The Air delivery of firmware to low power devices.

### BRIEF DESCRIPTION OF THE DRAWINGS

FIG. 1 illustrates an exemplary system and process 100 used for optimizing Over The Air (OTA) delivery of firmware to devices enabled for connectivity using static and dynamic information about the devices in accordance with one or more embodiments of the present invention.

FIG. 2A illustrates an exemplary system and process 200 for optimizing Over The Air (OTA) delivery of firmware to devices enabled for connectivity using static and dynamic information about the devices in accordance with an embodiment of the present invention.

FIG. 2B illustrates an exemplary system and process 200′ for optimizing Over The Air (OTA) delivery of firmware to devices enabled for connectivity using static and dynamic information about the devices in accordance with an embodiment of the present invention.

FIG. 2C illustrates an exemplary system and process 200″ for optimizing Over The Air (OTA) delivery of firmware to devices enabled for connectivity using static and dynamic information about the devices in accordance with an embodiment of the present invention.

FIG. 2D illustrates an exemplary system and process 200′″ for optimizing Over The Air (OTA) delivery of firmware to devices enabled for connectivity using static and dynamic information about the devices in accordance with an embodiment of the present invention.

FIGS. 3A-3F illustrate example criteria used for optimizing Over The Air (OTA) delivery of firmware to devices enabled for connectivity using static and dynamic information about the devices in accordance with one or more embodiments of the present invention.

FIG. 4 illustrates a data processing system 400 suitable for storing the computer program product and/or executing program code relating to the optimization of Over The Air (OTA) delivery of firmware to devices enabled for connectivity using static and dynamic information about the devices in accordance with one or more embodiments of the present invention.

### DETAILED DESCRIPTION

The present invention relates generally to optimization of over the air delivery of firmware to devices containing a product that enables connectivity for M2M or Internet of Things (IoT) devices using static information about the device in combination with dynamic information such as the connectivity status of the devices, location of the devices etc.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Although the invention is described with respect to product such as a Subscriber Identification Module (SIM), as used herein the term “product” is intended to be inclusive, interchangeable, and/or synonymous with appliances, electronic modules, telephony equipment and other similar products that require registration of distinct identifying numbers, such as ICCIDs, IMSIs, MEIDs or other serial numbers as described further below and collectively referred to herein as “numbers”, for that product with a service provider to receive services, though one will recognize that functionally different types of products may have characteristics, functions and/or operations which may be specific to their individual capabilities and/or deployment.

Devices, whether phones, radios or other types of hardware, known as M2M or Internet of Things (IoT) devices, that are intended to connect to networks, such as wireless or cellular networks, are enabled to connect to networks, such as by use with products such as Subscriber Identification Modules (SIMs). As IoT solutions are being deployed in high volume, the need and demand for the IoT devices to support efficient and scalable Over The Air (OTA) delivery of firmware is becoming stronger. In most cases, device companies that started with homegrown OTA solutions as an afterthought are encountering scalability and efficiency problems.

To overcome the issues described above with existing OTA delivery of firmware methods, the OTA service provider platform provides dynamic (e.g. real-time) information about conditions relevant to the one or more devices such as network connectivity status, network location of the devices using APIs or streaming information to improve operational efficiency and to optimize cost related to OTA delivery of the firmware.

While OTA delivery of software or software updates (SOTA) is becoming a norm, management of SOTA can be challenging. The simplest model is to collect device identifiers and trigger SOTA by sending a trigger, e.g., SMS to all devices to be updated. This relies on the assumption that all devices will be online to initiate download. Such assumptions mostly turn out to be wrong and result in unexpected issues and sometimes even outage, as there is no control or a model to predict when the devices will come online or go offline. As a result, there may be more than expected number of devices online and due to unexpected traffic OTA to some devices may fail, or cause servers to fail due to unplanned/unexpected load.

A better model is to manually group devices into discreet groups and run SOTA for one group at a time. However, such grouping and updates may require lot of manual effort and may take a lot of time to rollout critical updates to all the devices. Solutions like SOTA campaign management where the devices are grouped by attributes other than device identifier, for example, make and model of the device, device technology capability/features like V2V communication etc. may be faster and more efficient. The campaign management solutions may then schedule OTA updates in smaller batch sizes for the selected group. This allows for multiple concurrent campaigns which ensures faster rollout without putting unexpected load on the system.

While the campaign management solution may be effective it may still have a few limitations. Once a device is identified to be part of the active group and batch, it may be scheduled for update without regard to the current state of the device. The state of the device is more than just online/offline, for example, roaming, non-roaming, in data session, quality of network coverage, etc. Rather a device may have a window called OTA window, which may be designed for that particular device based on availability and/or state of that device.

In an embodiment, machine learning may be used to uniquely based on state as well as other parameters such as location, on/off status, connectivity state and/or status which may be deduced based on registration, data session, power level of the device, device roaming state (for example, only critical updates may be allowed when roaming), alternate connectivity states (push when Wi-Fi attached), rate plan changes for OTA (switch to higher usage or OTA specific rate plan) and then reset back to the original rate plans, automatic shoulder tap (SMS) for device wake-up, cost, etc. for a particular device identify OTA window for each device and to enhance the OTA solution. Such a system may not only benefit the OEMs but also the end customer. For example: 1. If user always plug-in the device at night and it is at the usual (home) location then performing OTA at that time will cause least inconvenience to the user resulting in optimization of user experience; 2. If a user is roaming then it is best to avoid OTA to avoid extra charge to the customer. In some cases OEMs pay for the OTA update and in such cases the cost savings could be huge for OEMs resulting in optimization of cost; 3. If a user has suspended the service then OTA update for such devices could be skipped to save time and money for the overall OTA data usage resulting in optimization of cost; 4. For OEMs the OTA is no more static or a single event, rather it could be continuous and never ending; 5. Manage data usage against the OTA, wherein an intelligent campaign may be built around the data usage optimization resulting in optimization of cost of delivery.

Additionally or alternatively, the automated OTA firmware delivery and/or updates may also be aware of network congestion by taking into account network status information. If the network demands of a population of devices simultaneously involved in an OTA update exceeds the shared available network bandwidth, a thrashing situation can occur where all updates continuously fail. Thus, in an embodiment, the method and system for Over The Air delivery of firmware to devices enabled for connectivity using connectivity status of the devices may further include receiving network status information and dynamically grouping the one or more devices based on the static device information, the dynamic device information and network status information. The network status information may include number of online devices, number of roaming devices, bandwidth available, number of devices connected to a specific network element (access point, cell-id etc.), utilization of network resources (server, routers, base stations, packet core etc.). The network status information may also include availability of network connectivity at the geographical location of the one or more devices. By taking into account the network status information such as but not limited to available network bandwidth, the location of nearby devices, and the connectivity status of the devices, delivery can be metered to increase OTA success rates, decreasing the time it takes to perform an update campaign across the entire target device population, and reducing connectivity costs related to failed downloads. One of the methods for detecting the nearby devices is described in the U.S. Pat. Nos. 9,002,348 and 9,680,727 entitled “UTILIZING DEVICES NEARBY” and is incorporated herein by reference.

To describe the features of the present invention in more detail within the context of IoT devices with products such as SIMs installed in them, for example, vehicles or sensors, refer to the accompanying figures in conjunction with the following discussions. These examples are used for purpose of illustration only, and should not be construed as limitations.

The embodiments described herein disclose a computer-implemented method and system for optimizing Over The Air delivery of firmware to devices enabled for connectivity using static as well as dynamic device information of the devices.

The computer-implemented method for optimizing Over The Air delivery of firmware to devices enabled for connectivity using static as well as dynamic device information of the devices comprises receiving static device information for the one or more devices; receiving dynamic device information for the one or more devices; dynamically grouping the one or more devices based on the static device information, the dynamic device information or the combination thereof; and dynamically scheduling Over The Air delivery of firmware using the grouping to the one or more devices enabled for connectivity.

The system for optimizing Over The Air delivery of firmware to devices enabled for connectivity using static as well as dynamic device information of the devices comprises one or more devices enabled for connectivity; an IoT platform for establishing an inventory of devices enabled for connectivity; an OTA platform configured to: receive static device information for the one or more devices; receive dynamic device information for the one or more devices; dynamically group the one or more devices based on the static device information, the dynamic device information or the combination thereof; and dynamically schedule Over The Air delivery of firmware using the grouping to the one or more devices enabled for connectivity.

In an embodiment, a computer program product for optimizing Over The Air delivery of firmware to devices enabled for connectivity using static as well as dynamic device information of the devices is also disclosed. The computer program product stored on a non-transferable computer readable medium for optimizing Over The Air delivery of firmware to devices enabled for connectivity using static as well as dynamic device information of the devices, comprising computer readable instructions for causing a computer to control an execution of an application for Over The Air delivery of firmware to one or more devices enabled for connectivity comprising receiving static device information for the one or more devices; receiving dynamic device information for the one or more devices; dynamically grouping the one or more devices based on the static device information, the dynamic device information or the combination thereof; and dynamically scheduling Over The Air delivery of firmware using the grouping to the one or more devices enabled for connectivity.

In an embodiment, the method and system for optimizing Over The Air delivery of firmware to devices enabled for connectivity using connectivity status of the devices may further include receiving network status information and dynamically grouping the one or more devices based on the static device information, the dynamic device information and network status information.

In an embodiment, the method and system for optimizing Over The Air delivery of firmware to devices enabled for connectivity using connectivity status of the devices may be enhanced by using an agent. In an embodiment, the method and system for Over The Air delivery of firmware to devices enabled for connectivity using connectivity status of the devices may be agentless.

In an embodiment, the method and system for optimizing Over The Air delivery of firmware to devices enabled for connectivity using connectivity status of the devices may include Over The Air delivery of firmware to low power devices.

In yet another embodiment, the method and system for optimizing Over The Air (OTA) delivery of firmware to devices enabled for connectivity using connectivity status of the devices may include Over The Air (OTA) artifact hosting close to the edge to reduce overall latency and result in efficient use of available bandwidth.

Once the original equipment manufacturer (OEM) of devices enabled for connectivity has provided connected hardware for vertical specific solution (e.g. healthcare, fleet, solar, asset tracking), these connected devices which have software and/or firmware that need to be remotely upgraded for various reasons such as but not limited to: security & privacy related fixes, software/firmware bug fixes and new features and capabilities. The scalable and connectivity aware OTA firmware delivery solution is particularly beneficial as these connected devices may have long lifetimes (e.g. deployed/used in the field for over 12 months) and may be deployed in remote locations (hard to access), where most device may not have a user interface. If the OEM has large fleet of devices (over 5K devices) manual upgrade for all the devices is not only cumbersome, it may be difficult to accomplish. For OEMs, leveraging an OTA firmware delivery service provided by the network provider itself may lead to overall higher reliability and allow them to focus on more value-added features.

The most challenging aspect of OTA delivery of firmware in large scale is coordination with connectivity. For example, upgrading fleet of hundreds of thousands of cars due to recall, or updating thousands of devices to patch security issues or updating thousands of resource constrained devices that require careful management of available bandwidth etc. The computer-implemented method and system for the Over The Air (OTA) delivery of firmware offers significant reduction in operational complexity and associated operational costs for OTA firmware delivery management. OTA campaign manager may eliminate manual operations by simplifying OTA campaign management by streamlining device targeting, executing upgrades, tracking progress, and automating retries for failed upgrades. It may also offer significant reduction in the actual execution time for large-scale OTA firmware delivery/updates.

Campaign automation with connectivity state awareness may increase OTA firmware delivery success rates for large fleets of devices by decreasing time to complete campaign. For example, OTA firmware deliveries that may take 3-6 months may be accomplished in 1-2 weeks and may also optimize connectivity costs for OTA firmware delivery campaigns because of dedicated OTA rate plans with automatic assignment.

Integration with connectivity management platform may offer additional advantage of automating rate plan changes and/or assignments to increase cost efficiency and increased security by preventing breaches during an update, and by preventing unwanted updates from 3rd party servers. Mutual authentication along with just-in-time OTA firmware downloads ensures that the correct updates go to the right devices, and the devices are protected from unauthorized update attempts.

Additionally, campaign automation with connectivity state awareness may protect the device application data by isolating OTA firmware updates so that they do not impact application performance. Distributed OTA file hosting along with a content delivery network (CDN) for delivery reduces risk of back-end network congestion for large scale campaigns. Campaign automation with connectivity state awareness may also optimize OTA firmware delivery for battery sensitive or low power devices. This increased efficiency may minimize retries, automated pause/resume downloads may fit downloads into scheduled device behavior, and ‘shoulder-tap’ capabilities may reduce unnecessary OTA availability polling.

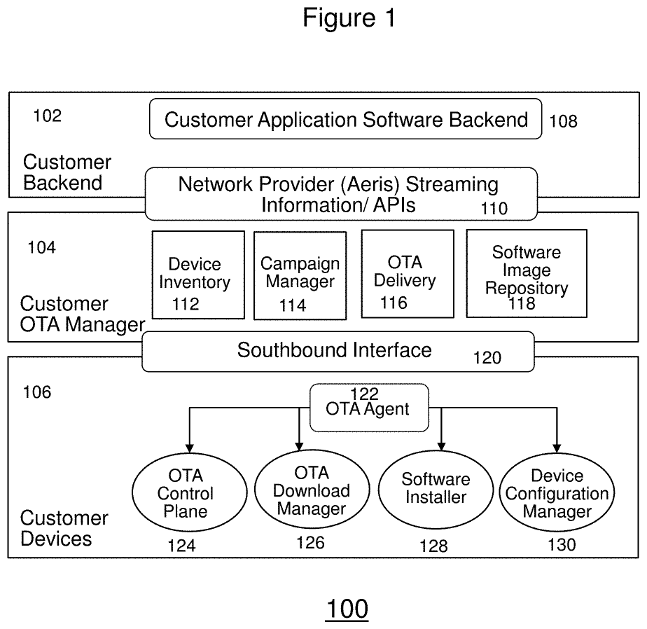

FIG. 1 illustrates an exemplary system and process 100 for Over The Air (OTA) delivery of firmware to devices enabled for connectivity using connectivity status of the devices in accordance with an embodiment of the present invention. In an embodiment, the system 100 and process for Over The Air (OTA) delivery of firmware to devices enabled for connectivity using connectivity status of the devices includes a customer backend 102, Customer OTA manager 104 and Customer devices 106. The customer backend 102 includes customer application software backend 108, which is connected to customer OTA manager 104 via network provider, e.g., Aeris, streaming information/APIs 110. The customer OTA manager 104 includes device inventory 112, campaign manager 114, OTA delivery 116 and software image repository 118. The customer OTA manager 104 is connected to connected to customer devices 106 via southbound interface 120. The customer devices 206 includes OTA agent 122 which further includes OTA control plane 124, OTA download manager 126, software installer 128 and device configuration manager 130.

In an embodiment, the flexible software repository options as illustrated by software image repository 118 may include maintenance of software repository at network edge (network provider, e.g., Aeris, backend) and/or software repository at customer location.

Flexible OTA agent 122 options may include any one or more of: a full stack Linux based OTA device agent (using MQTT), OTA device agent SDK—enable Customer to integrate with their device application, HTTP based REST interface specification enables customer to develop complete OTA device client using the REST specification and end customer notification & user acceptance.

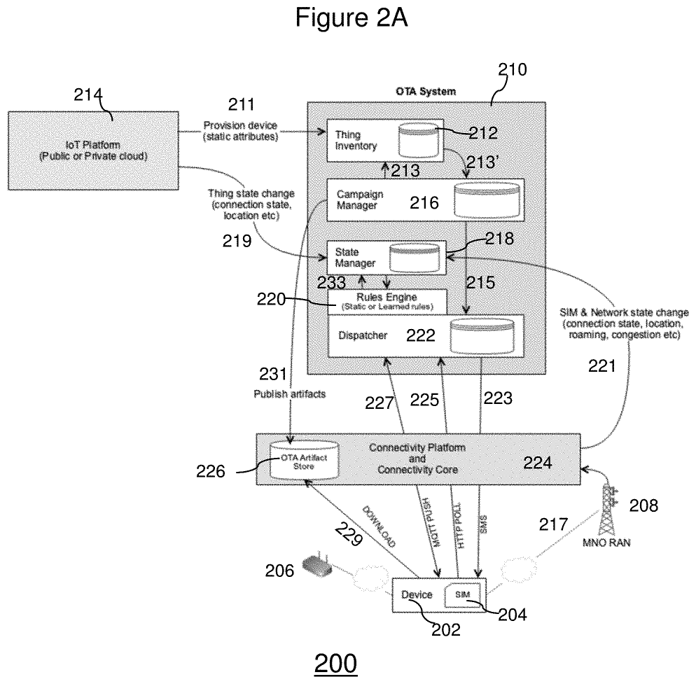

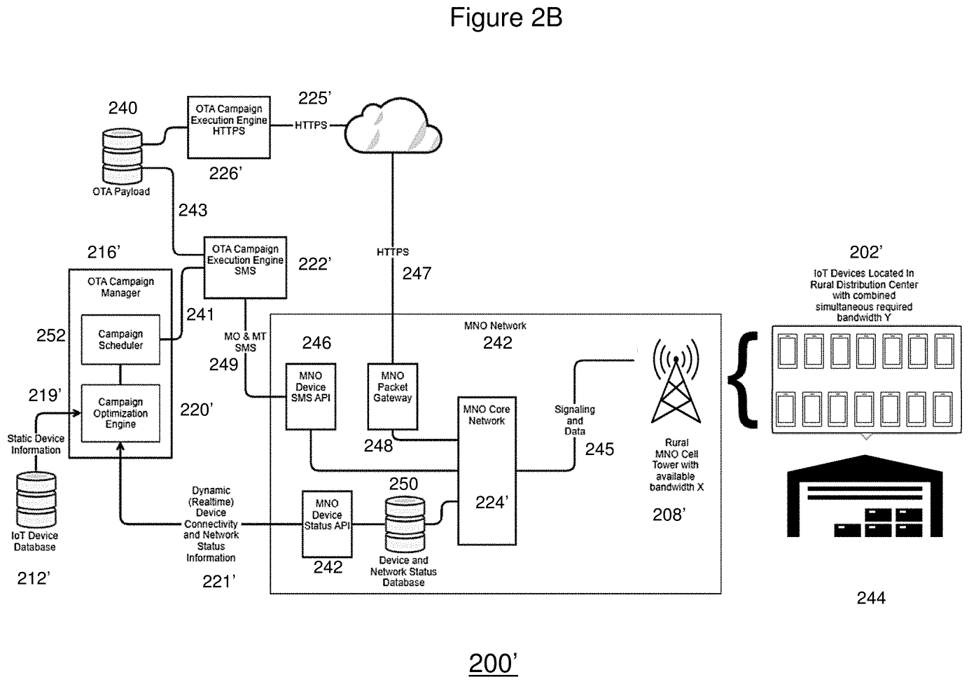

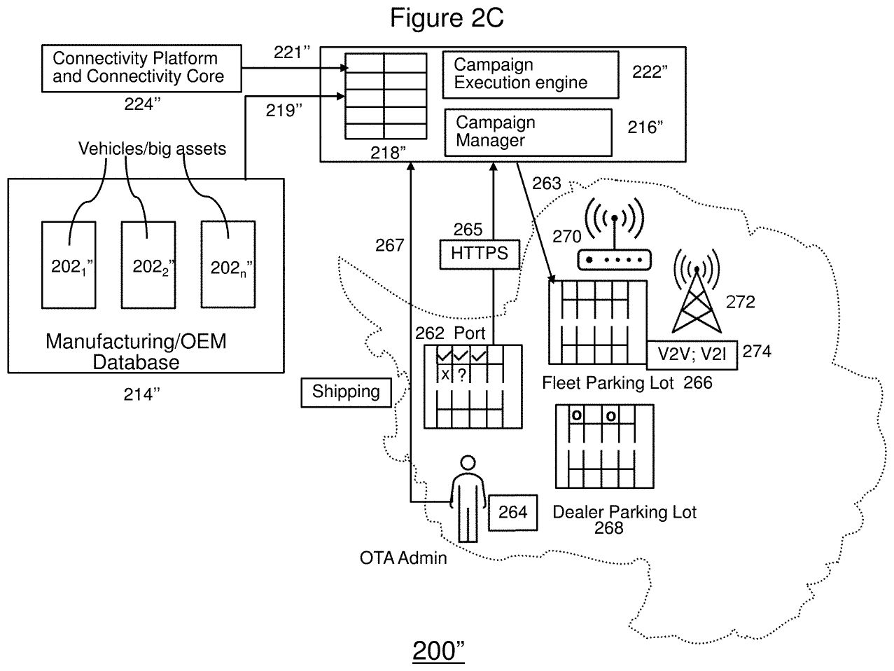

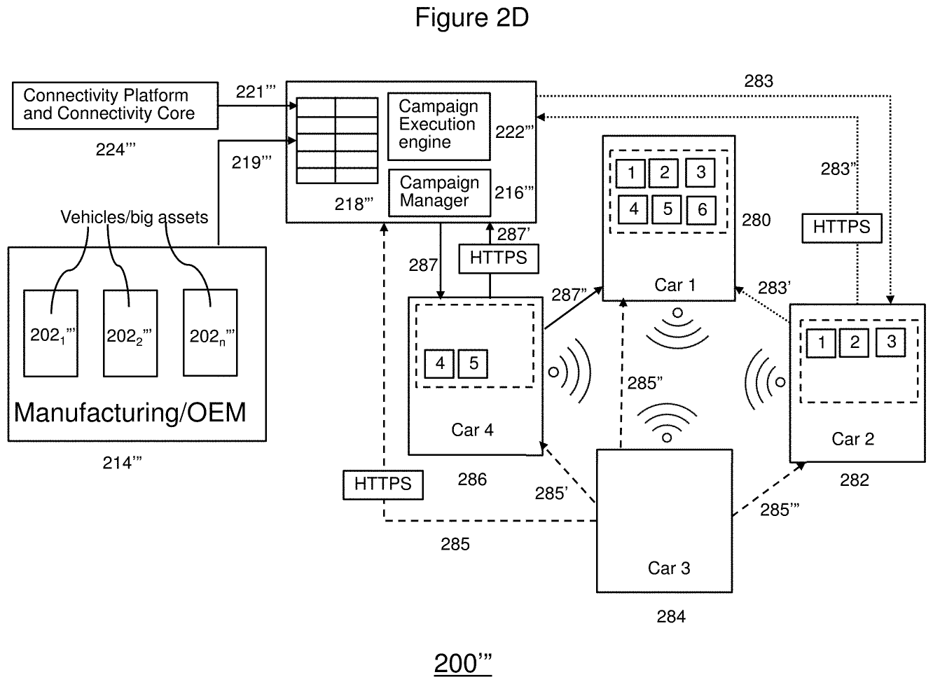

FIG. 2A illustrates an exemplary system and process 200 used for Over The Air (OTA) delivery of firmware to devices enabled for connectivity using connectivity status of the devices which may be deduced based on device registration, data session etc. The system 200 comprises one more devices, illustrated as an exemplary device 202, which are enabled for connectivity using a connectivity module 204, e.g., SIM. Over The Air (OTA) delivery of software and/or firmware for IoT devices may be accomplished by OTA platform 120 using one or more of the components of OTA platform 210 including a thing inventory 212, campaign manager 216, state manager 218, rules engine 220 and a dispatcher 222.

The inventory of things/devices 212 is saved in a storage database and may be queried as needed to identify the devices that need OTA update by campaign manager 216 via step 213 and receive inventory updates and/or other information via step 213′. Campaign Manager 216 manages grouping and scheduling of OTA update for target devices and implements complex workflows with respect to consent and approvals. Campaign Manager 216 also publishes OTA content/image to the OTA Content Store (not shown) hosted in Connectivity Core platform 224.

State Manager 218 holds state updates for the devices or things received from multiple sources like IoT Platform 214 and Connectivity Platform 224.

Rules Engine 220 hosts rules to be evaluated to identify the devices that should be scheduled for OTA update. In an embodiment, the rules engine 220 may include static rules, learned rules or a combination thereof. The rules engine 220 may be located within the dispatcher 222 or outside the dispatcher 222. The state manager 218 communicates with rules engine 220 via step 233. The rules engine 220 evaluates rules based on the device and/or network state information from state manager 218.

Dispatcher 222 implements various protocols over which the OTA update actions can be dispatched to the devices. Dispatcher 222 uses rules engine 220 to filter the devices that must be notified/scheduled for OTA update. Devices, e.g., 202, send status updates to the dispatcher 222 regarding state of download and/or install.

The system 200 may further include a public and/or private cloud IoT platform 214 and a connectivity platform and connectivity core 224. Connectivity platform 224 is a connectivity management platform responsible for provisioning and managing connectivity. Connectivity Core also illustrated as 214 refers to the core connectivity network components through which device connects to IoT platform 214 and OTA platform 210. Thus, device 202 connects to the connectivity platform and connectivity core 224 to further connect to the IoT platform 214 and OTA platform 210 via mobile network operator, e.g., AT&T, Verizon, T Mobile, Sprint etc., radio access network (MNO RAN) 208. The public and/or private cloud IoT platform 214 is a software platform for building IoT applications. It can be a private platform hosted in public cloud or it can be a platform hosted and managed by public cloud providers, for example, Google, Amazon, Azure etc. and manages and updates things, e.g., provisioning IoT devices and updating inventory of things/devices 212 via step 211.

This inventory of things/devices 212 is saved in a storage database and may be queried as needed to identify the devices that need OTA update. The inventory 212 may further include attributes associated with each thing or device 202. This attributes/information may be static, e.g., device identifier, make, model, device technology capability/features like V2V communication, etc. of the device, or dynamic, e.g., location, on/off status, connectivity status of the device which may be deduced based on registration, data session, power level of the device. The dynamic attributes/information may further include whether the device is roaming or using a home network, availability of Wi-Fi connectivity to the device, availability of cellular connectivity to the device, availability of bandwidth to the device based on time of the day, availability of bandwidth to the device based on a shared network resource, cost of operation based on time of the day, billing state of the device, location of the device based on network, subscription management awareness of the device, Quality of Service (QoS), network congestion awareness, Data session awareness, geographical location of the devices, availability of network resources at the geographical location of the devices, number of other devices at the geographical location, network status at the location of the devices and availability of peers with capability to download OTA content via peer to peer technology. One of the methods for detecting the nearby devices is described in the U.S. Pat. Nos. 9,002,348 and 9,680,727 entitled “UTILIZING DEVICES NEARBY” and is incorporated herein by reference.

The automated OTA software and/or firmware delivery and/or updates takes into account these and other attributes when applying dynamic rules and/or campaigns, e.g., device attributes such as product code, model #, software version, etc., device connectivity state (e.g. device not in session), device location (e.g., devices in USA, zip-code based location detection, etc.), device roaming state (only critical updates allowed when roaming), alternate connectivity states (push when Wi-Fi attached), rate plan changes for OTA (switch to higher usage or OTA specific rate plan) and then reset back to the original rate plans, automatic shoulder tap (SMS) for device wake-up.

Additionally or alternatively, the automated OTA firmware delivery and/or updates may also be aware of network congestion by taking into account network status information. Thus, in an embodiment, the method and system for optimizing the Over The Air delivery of firmware to devices enabled for connectivity using static and dynamic information about the devices may further include receiving network status information and dynamically grouping the one or more devices based on the static device information, the dynamic device information and network status information. The network status information may include number of online devices, number of roaming devices, bandwidth available, number of devices connected to a specific network element (access point, cell-id etc.), utilization of network resources (server, routers, base stations, packet core etc.).

For example, if the network demands of a population of devices simultaneously involved in an OTA update exceeds the shared available network bandwidth, a thrashing situation can occur where all updates continuously fail. Thus, in an embodiment, the method and system for Over The Air delivery of firmware to devices enabled for connectivity using static as well as dynamic information about the devices may further include receiving network status information including availability of network services and/or availability of bandwidth for the devices and dynamically grouping the one or more devices based on the static device information, the dynamic device information and network status information.

The network status information may include number of online devices, number of roaming devices, bandwidth available, number of devices connected to a specific network element (access point, cell-id etc.), utilization of network resources (server, routers, base stations, packet core etc.). The network status information may also include availability of network connectivity at the geographical location of the one or more devices. By taking into account the network status information such as but not limited to available network bandwidth, the location of nearby devices, and the connectivity status of the devices, delivery can be metered to the impacted population of devices to increase OTA success rates, decreasing the time it takes to perform an update campaign across the entire target device population, and reducing connectivity costs related to failed downloads. This is illustrated in FIG. 2B and described in detail in the description accompanying FIG. 2B.

Additionally or alternatively, the system and method for optimizing the automated OTA firmware delivery and/or updates may be made aware of the location of the IoT devices. Many times, the IoT devices are manufactured in a facility and are shipped from there to different locations, such as different locations in a country or to different countries. Due to differing laws at these various locations, the IoT devices may require different software/firmware updates that would help the devices comply with the regional requirements and/or get services available for that particular region. The campaign manager 216 may receive this location information and/or network resources available at that particular location as the devices are received at a particular location as part of the dynamic device information along with one or more parameters described above and schedule the OTA delivery based on that information. This is illustrated in FIG. 2C and described in detail in the description accompanying FIG. 2C.

Additionally or alternatively, the system and method for optimizing the automated OTA firmware delivery and/or updates may make use of peer to peer technology, for example, vehicle to vehicle (V2V) technology, wherein rather than delivering the entire content from cloud to a vehicle, the vehicle may receive the content entirely or in parts from the cloud or from the surrounding vehicles, which may already have downloaded the content. Such use of peer-to-peer technology for OTA delivery of software/firmware updates may have several advantages, including but not limited to speed, cost and may also avoid network congestion. This is illustrated in FIG. 2D and described in detail in the description accompanying FIG. 2D.

The connectivity platform 224 may provide information such as connectivity status of the devices which may be deduced based on registration, data session, which may be checked by the dispatcher 222 from time to time, e.g., when the dispatcher 222 has a new update to push, or the dispatcher 222 may subscribe to the connectivity status and/or connectivity status change of the devices, such that when the connectivity status is a pre-defined status, it can trigger an OTA firmware delivery/update via SMS via step 223 or via MQTT Push via step 227. Some devices may use the HTTP/HTTPS POLL mechanism via step 225 to find if there is OTA update available. The SMS/MQTT Push mechanism is preferred over HTTP/HTTPS POLL due to scalability, data usage(cost) and bandwidth optimization.

The device 202 then downloads the OTA firmware/software images from OTA Artifact Store 226. OTA Artifact Store 226 holds the OTA firmware/software images downloaded from the campaign manager 216 via step 231 close to Connectivity Core 224 for faster download of content onto the device 202 via step 229. OTA images could range between few KBs to few GBs depending on the IoT device and application.

Additionally or alternatively, the connectivity platform 224 may take into account network traffic such that it is aware of network congestion. This congestion awareness is achieved by further receiving network status information and dynamically grouping the one or more devices based on the static device information, the dynamic device information and network status information. The network status information may include any one or more of: number of online devices, number of roaming devices, bandwidth available, number of devices connected to a specific network element (access point, cell-id etc.), utilization of network resources such as server, routers, base stations, packet core, other network devices etc., for example, router 206.

The state manager 218 can manage thousands of concurrently connected devices and may provide information such as connectivity status of the devices which may be deduced based on registration, data session, and network status, which may be checked by campaign manager 216 from time to time, e.g., when the campaign manager 216 has a new update to push, or the campaign manager 216 may subscribe to the connectivity status and/or connectivity status change of the devices through state manager 218 via step 221, such that when the connectivity status is a pre-defined status, it can trigger an OTA firmware delivery/update through dispatcher 222 via step 215 by sending an SMS to the device 202 via step 223.

Thus, the inventory of things includes static information about the things, or the devices enabled for connectivity received from IoT platform which includes static information such as device identifier, device technology capability/features like V2V communication, and make and model of the device. The dynamic information about the things or the devices enabled for connectivity is received from connectivity platform 224 and/or connectivity core and may include one or more of: connectivity status of the device 202 which may be deduced based on registration, data session, whether the device 202 is roaming or using a home network, availability of Wi-Fi connectivity to the device 202, e.g., online/offline, availability of cellular connectivity to the device 202, availability of bandwidth to the device 202 based on time of the day, availability of bandwidth to the device 202 based on a shared network resource, network status at the location of the devices, cost of operation based on time of the day, billing state of the device 202, e.g., provisioned/suspended/billable etc., location of the device 202 based on network (cell-Id, access point, latitude/longitude), subscription management state of the device 202 e.g., no OTA delivery of firmware when the device 202 is using a bootstrap profile etc., location of the device 202 (for e.g., zip code, street address or GPS co-ordinates etc.), Quality of Service (QoS), e.g., multiple APNs, Data session awareness, geographical location of the devices 202, availability of network resources at the geographical location of the devices 202, number of other devices at the geographical location, network status at the location of the devices 202 and availability of peers with capability to download OTA content via peer to peer, etc.

The automated OTA firmware delivery system and method thus dynamically groups the devices 202 based on this static as well as dynamic information and dynamically schedules the Over The Air delivery of firmware based on such groupings.

The automated OTA firmware delivery network may be designed to optimize operations for large scale deployments, such that OTA delivery campaign execution doesn't congest various network links. It may also provide lower latency for the campaign execution and may use information regarding connectivity state (Active, suspended etc.) and device registration to minimize failures.

In an embodiment, the OTA firmware delivery method and system may additionally or alternatively include a security architecture, which may be industry standard protocol, for example, HTTPS, providing transport security, device authentication and download security. For example, as transport security, all interaction between the devices and the OTA firmware delivery server may take place over transport layer security (TLS). This may include HTTP and/or MQTT interface and may use criteria such as device having a root and intermediate CA that issues OTA certificate in their truststore.

For device authentication, the device 202 may obtain time bound JSON Web Token (JWT access token) by authenticating with network provider's e.g., Aeris, authorization service (AzS). The JWT token may be used by client to access OTA APIs (HTTP or MQTT), where JWT is validated by OTA firmware delivery service. The device can authenticate with AzS several ways, e.g., mutual TLS, client and server exchange certificates, JWT authentication, where network provider's authorization service, e.g., Aeris AzS, validates non-network provider's, e.g., non-Aeris, JWT, issues network provider JWT, public/private key, where each device provisioned with unique public/private key (usually residing in a secure element (SE)) and public keys provided to AzS. Client may obtain signed JWT from device SE. AzS uses public key to validate JWT, and issues network provider JWT.

For download security, a unique and short-lived URL may be provided to each client for downloads. After the download is either successful or determined to have failed, the URL is invalidated. Downloads may use HTTPS. Download file repository may be implemented as AWS S3 bucket, e.g., S3 bucket may be locked down via account ACLs to only OTA firmware delivery backend, and/or files may be encrypted using AES-256. The download security may also offer option to download via network provider's OTA firmware delivery backend, or directly from a third party download server.

FIG. 2B illustrates an exemplary system and process 200′ for optimizing Over The Air (OTA) delivery of firmware to devices enabled for connectivity using both static and dynamic information about the devices in accordance with an embodiment of the present invention. The dynamic information may include real time conditions such as but not limited to the connectivity status of the devices along with network information such as but not limited to network status, where the network used for the delivery of OTA may have limited bandwidth. In which case it may be helpful to know the device connection status, but also the number of devices at the location that are competing for bandwidth on the same cell tower. Potential thrashing and OTA update failures based on insufficient wireless network bandwidth may occur when combined required device bandwidth Y exceeds the available tower bandwidth X.

The system and method for optimization of the automated OTA firmware delivery and/or updates may also be aware of network congestion by taking into account network status information. If the network demands of a population of devices simultaneously involved in an OTA update exceeds the shared available network bandwidth, a thrashing situation can occur where all updates continuously fail. Thus, in an embodiment, the method and system for optimizing Over The Air delivery of firmware to devices enabled for connectivity using static and dynamic information about the devices may further include receiving network status information at the location of the devices, for example, if the network at the location of the device/e is on or off; geographical location of the devices; availability of network resources at the geographical location of the devices; number of other devices at the geographical location; and dynamically grouping the one or more devices based on the static device information, the dynamic device information and the network status information.

As illustrated in FIG. 2B, for example, a number of IoT devices 202′ are manufactured and sent to a distribution center 260. The distribution center 260 may be located at a remote location such as rural areas where the availability of network bandwidth is limited. Combined bandwidth required for simultaneous Over The Air delivery of firmware for all the IoT devices 202′ may be Y, whereas the rural MNO cell tower 208′ may have available network bandwidth X. In such cases, a thrashing situation can occur if the available bandwidth X is less than the required bandwidth Y in which case all updates may continuously fail as described above. The method and system according to an embodiment described herein may take into account this network status information and dynamically group the one or more devices based on the static device information, the dynamic device information and the network status information.

The network status information may include actual network status of the network such as if the network at the location of the device/e is on or off, along with other network information related to the devices of interest such as number of online devices, number of roaming devices at that location, availability of bandwidth to the device based on a shared network resource, number of devices connected to a specific network element (access point, cell-id etc.), utilization of network resources (server, routers, base stations, packet core etc.). By taking into account available the network information related to the impacted population of the devices such as but not limited to, network bandwidth, the location of nearby devices, and the connectivity status of the devices, delivery can be metered to the impacted population of the devices to increase OTA success rates, decreasing the time it takes to perform an update campaign across the entire target device population, and reducing connectivity costs related to failed downloads. One of the methods for detecting the nearby devices is described in the U.S. Pat. Nos. 9,002,348 and 9,680,727 entitled “UTILIZING DEVICES NEARBY” and is incorporated herein by reference.

This network status information and network information related to the devices is collected by device and network status database 250 via MNO core network 242 along with MNO device status information received via MNO device status API and provided to campaign optimization engine 220′ via step 221′. The campaign optimization engine 220′ also receives static device information from IoT device database 212′ via step 211′ and provides the combined information to the campaign scheduler 252. The campaign optimization engine 220′ may include functional components such as a rules engine 220 and a state manager 218 as illustrated in FIG. 2A and described in detail in the description accompanying FIG. 2A. The state manager 218 which may be a separate functional component within the OTA campaign manager 216′ or a part of the campaign optimization engine 220′ and holds state updates for the devices or things received from multiple sources like IoT device database 212′ (similar to Things inventory 212 illustrated in FIG. 2A) and MNO core network 224′ (similar to connectivity platform 224 illustrated in FIG. 2A). The campaign optimization engine 220′ and the campaign scheduler 252 are functional components of OTA campaign manager 216′ illustrated herein is similar to the OTA campaign manager 216 illustrated in FIG. 2A. The campaign scheduler 252 uses this information dynamically to efficiently schedule OTA delivery, which is conveyed to OTA campaign execution engine 222′ via step 241 which received OTA payload to be delivered from OTA payload database 240 via step 243.

The OTA campaign execution engine 222′ also illustrated as the dispatcher 222 in FIG. 2A may subscribe to the dynamic information change of the devices such that when the dynamic information such as network status information and bandwidth availability information is a pre-defined status, it can trigger an OTA firmware delivery/update via SMS via step 249 as illustrated in FIG. 2B. For download security, a unique and short-lived URL may be provided to each client/device for downloads from OTA campaign execution engine HTTPS 226′. After the download is either successful or determined to have failed, the URL is invalidated. The OTA firmware delivery method and system may additionally or alternatively include a security architecture, which may be industry standard protocol, for example, HTTPS, providing transport security, device authentication and download security.

FIG. 2C illustrates an exemplary system and process 200″ for optimizing Over The Air (OTA) delivery of firmware to devices enabled for connectivity using static and dynamic information about the devices in accordance with an embodiment of the present invention. The static information regarding one or more of the IoT devices 202₁″, 202₂″, . . . 202ₙ″ may be provided to the campaign manager 216″ via step 219″ by the manufacturing/OEM database, which may also simply be an IoT database/inventory 214″. The dynamic information regarding the devices may include the location of the IoT devices 202₁″, 202₂″, . . . 202ₙ″ along with one or more of: connectivity status of the devices 202₁″, 202₂″, . . . 202ₙ″ which may be deduced based on registration, data session, whether the devices 202₁″, 202₂″, . . . 202ₙ″ are roaming or using a home network, availability of Wi-Fi connectivity to the devices 202₁″, 202₂″, . . . 202ₙ″, e.g., online/offline, availability of cellular connectivity to the devices 202₁″, 202₂″, . . . 202ₙ″, availability of bandwidth to the devices 202₁″, 202₂″, . . . 202ₙ″ based on time of the day, availability of bandwidth to the devices 202₁″, 202₂″, . . . 202ₙ″ based on a shared network resource, cost of operation based on time of the day, billing state of the devices 202₁″, 202₂″, . . . 202ₙ″, e.g., provisioned/suspended/billable etc., location of the devices 202₁″, 202₂″, . . . 202ₙ″ based on network (cell-Id, access point, latitude/longitude), subscription management state of the devices 202₁″, 202₂″, . . . 202ₙ″ e.g., no OTA delivery of firmware when the devices 202₁″, 202₂″, . . . 202ₙ″ are using a bootstrap profile etc., location of the devices 202₁″, 202₂″, . . . 202ₙ″ (for e.g., zip code, street address or GPS co-ordinates etc.), Quality of Service (QoS), e.g., multiple APNs, Data session awareness etc. as described above in the description accompanying FIG. 2A.

Many times, the IoT devices are manufactured in a facility and are shipped from there to different locations and/or regions, such as different regions in a country or to different countries. Due to differing laws at these various regions (countries/states/municipalities), the IoT devices may require different software/firmware updates that would help the devices comply with the regional requirements and/or get services available for that particular region. The campaign manager 216 may receive this region information as the devices are received at a particular location as part of the dynamic device information along with one or more parameters described above and schedule the OTA delivery and content of the delivery based on that location information. The content of the OTA delivery may be further tailored based on the destination of a particular IoT device.

As illustrated in FIG. 2C, for example, a number of IoT devices 202₁″, 202₂″, . . . 202ₙ″ are manufactured at a manufacturing facility and sent to a distribution center 260. These devices then may be stored or located in different places, for example, vehicles may be stored in a port parking lot 262, or a fleet parking lot 266 or a dealership parking lot 268. In such cases, the number of IoT devices can be a large number, for example, thousands to hundreds of thousands, which may cause network congestion if OTA delivery of firmware/software to all the devices is started at the same time. The campaign manager 216″ may receive information about available resources for such downloads as part of dynamic device information. The resources available may include one or more cell towers 272, one or more Wi-Fi networks 270, other resources 274, such as vehicle to vehicle (V2V) resource, vehicle to cloud (V2C) resource, vehicle to infrastructure (V2I) resource, which could be a WiFi access point on a light pole, a private LTE micro-cell or a charging endpoint for electric vehicles, vehicle to anything resource (V2X), etc. For example, once the campaign manager realizes that the vehicles are at a port, the OTA delivery may be performed using a local Wi-Fi or other short-range communication means. The campaign manager 216″ may thus also take into account the availability of these resources at a particular location for optimization of OTA delivery. For example, for larger devices such as vehicles the other resources may include vehicle to vehicle (V2V) resource, vehicle to cloud (V2C) resource, whereas for smaller IoT devices the other resources may include short range communication endpoints like Wi-Fi access point or Zigbee hub.

The OTA campaign manager 216″ may include functional components such as a rules engine 220 as illustrated in FIG. 2A and a state manager 218″. The state manager 218″ which may be a separate functional component within the OTA campaign manager 216″ or a part of the campaign optimization engine 222″ holds state updates for the devices or things received from multiple sources like IoT device database 214″ (similar to IoT platform 214 illustrated in FIG. 2A) via step 219″ and connectivity platform 224″ via step 221″.

The OTA campaign manager 216″ may include a campaign execution engine 222″ (or a dispatcher 222 illustrated in FIG. 2A), which may subscribe to the dynamic information change of the devices such that when the dynamic information such as location of the device, status of OTA firmware delivery/update, device connection status, device connection profile etc, and can present a user friendly interface for the OTA admin to track the OTA update progress for the fleet in the location as illustrated in FIG. 2C. For download security, a unique and short-lived URL may be provided to each client/device for downloads from 222″. After the download via step 265 is either successful or determined to have failed, the URL is invalidated. The OTA firmware delivery method and system may additionally or alternatively include a security architecture, which may be industry standard protocol, for example, HTTPS, providing transport security, device authentication and download security.

Additionally or alternatively, these devices then may be stored or located in different organized, traceable places. For example, vehicles may be stored in a port parking lot 262, or a fleet parking lot 266 or a dealership parking lot 268 and VIN number of each vehicle may be associated with a certain parking space number. In an embodiment, an OTA administrator 264 may be provided with a visual representation of the port parking lot 262, or a fleet parking lot 266 or a dealership parking lot 268 and the OTA administrator 264 can visually see the completion or failure of the OTA delivery for the vehicles 202₁″, 202₂″, . . . 202ₙ″ parked in the parking lots. The OTA administrator 264 may then communicate with the campaign manager 216″ via step 267 in an effort to fix the reasons for the failure.

Although the embodiments described herein use vehicles as an example, the person skilled in the art may readily realize that it can be easily applicable to other IoT devices, where OTA delivery is based on location of the devices and information regarding availability of different network resources at that location as dynamic information regarding the IoT devices.

FIG. 2D illustrates an exemplary system and process 200′″ for optimizing Over The Air (OTA) delivery of firmware to devices enabled for connectivity as well as peer to peer technology using static and dynamic information about the devices in accordance with an embodiment of the present invention. For example, rather than delivering the entire content from cloud to a vehicle, the vehicle may receive the content entirely or in parts from the cloud or from the surrounding vehicles, which may already have downloaded the content using vehicle to vehicle (V2V) technology. Such use of peer-to-peer technology for OTA delivery of software/firmware updates may have several advantages, including but not limited to speed, cost and may also avoid network congestion.

The static device information may include one or more of: device identifier, device technology capability/features like V2V communication, make and model of the device and location of the device. The dynamic information may include location of the IoT devices, surrounding IoT devices with static and dynamic information that may be grouped together based on static information such as device identifier, device technology capability/features like V2V communication, make and model of the device and location of the device as well as other dynamic information.

The static information regarding one or more of the IoT devices 202₁′″, 202₂′″, . . . 202ₙ′″ may be provided to the campaign manager 216′″ via step 219′″ by the by the manufacturing/OEM database, which may also simply be an IoT database/inventory 214″. The other dynamic information about the devices may include one or more of: connectivity status of the devices 202₁′″, 202₂′″, . . . 202ₙ′″ which may be deduced based on registration, data session, whether the devices 202₁′″, 202₂′″, . . . 202ₙ′″ are roaming or using a home network, availability of Wi-Fi connectivity to the devices 202₁′″, 202₂′″, . . . 202ₙ′″, e.g., online/offline, availability of cellular connectivity to the devices 202₁′″, 202₂′″, . . . 202ₙ′″, availability of bandwidth to the devices 202₁′″, 202₂′″, . . . 202ₙ′″ based on time of the day, availability of bandwidth to the devices 202₁′″, 202₂′″, . . . 202ₙ′″ based on a shared network resource, cost of operation based on time of the day, billing state of the devices 202₁′″, 202₂′″, . . . , 202ₙ′″, e.g., provisioned/suspended/billable etc., location of the devices 202₁′″, 202₂′″, . . . 202ₙ′″ based on network (cell-Id, access point, latitude/longitude), subscription management state of the devices 202₁′″, 202₂′″, . . . 202ₙ′″, e.g., no OTA delivery of firmware when the devices 202₁′″, 202₂′″, . . . 202ₙ′″ are using a bootstrap profile etc., location of the devices 202₁′″, 202₂′″, . . . 202ₙ′″ (for e.g., zip code, street address or GPS co-ordinates etc.), Quality of Service (QoS), e.g., multiple APNs, Data session awareness, geographical location of the devices, availability of network resources at the geographical location of the devices, number of other devices at the geographical location, network status at the location of the devices and availability of peers with capability to download OTA content via peer to peer technology, etc. as described above in the description accompanying FIG. 2A.

Similar to FIG. 20, FIG. 2D illustrates OTA campaign manager 216′″ may include functional components such as a rules engine 220 as illustrated in FIG. 2A and a state manager 218′″. The state manager 218′″ which may be a separate functional component within the OTA campaign manager 216′″ or a part of the campaign optimization engine 222′″ holds state updates for the devices or things received from multiple sources like IoT device database 214′″ (similar to IoT platform 214 illustrated in FIG. 2A) via step 219′″ and connectivity platform 224″ via step 221″.

The OTA campaign manager 216′″ may include a campaign execution engine 222″ (or a dispatcher 222 illustrated in FIG. 2A), subscribe to the dynamic information such as location of the device, capability of device to support V2V download, number of devices nearby with same capability, and it can trigger the OTA firmware delivery/update, via SMS or MQTT as explained in the description of FIG. 2A, by creating variable size groups. Once the OTA firmware delivery/update is triggered, the devices can discover nearby devices and download chunks of the OTA artifact from other devices via vehicle to vehicle (V2V) or other peer to peer (P2P) interface via steps 283 for car 2 282, step 287 for car 4 286 as illustrated in FIG. 2D. One of the methods for detecting the nearby devices is described in the U.S. Pat. Nos. 9,002,348 and 9,680,727 entitled “UTILIZING DEVICES NEARBY” and is incorporated herein by reference.

For download security, a unique and short-lived URL may be provided to each client/device for downloads from 222″. After the download, for example, via steps 283′ for car 2 282, step 287′ for car 4 286, is either successful or determined to have failed, the URL is invalidated. The OTA firmware delivery method and system may additionally or alternatively include a security architecture, which may be industry standard protocol, for example, HTTPS, providing transport security, device authentication and download security.

However, the downloads may be incomplete for a variety of reasons, in which case the vehicle may receive the content entirely or in parts from the cloud or from the surrounding vehicles, which may already have downloaded the content using vehicle to vehicle (V2V) technology or other peer to peer interface.

For example, car 1 280 may have received the OTA delivery and has a complete update content including parts 1-6, whereas car 2 282 may have downloaded the content with only parts 1, 2, 3, and car 4 286 may have downloaded the content with only parts 4 and 5, which may happen for a variety of reasons. Car 3 284 has not downloaded the content at all. In the present scenario car 2 282 is looking to download parts 4, 5 and 6 of the content, which it may download from 222′″ via step 283″ as scheduled by the campaign manager 216′″ or by using peer to peer technology from car 1 280 via step 283′. Similarly, car 4 286 is looking to download parts 1, 2, 3 and 6 of the content, which it may download from 222′″ via step 287′ as scheduled by the campaign manager 216′″ or by using peer to peer technology from car 1 282 via step 287″. Car 3 284 has not downloaded the content at all, and it may download either parts of the update based on availability, for example, parts 1, 2, 3 from car 2 282 via step 285′″ or parts 4 and 5 from car 4 286 via step 285′ or the entire update from 222′″ via step 285″.

Although the embodiments described herein use cars as an example, the person skilled in the art may readily realize that it can be easily applicable to other IoT devices, where OTA delivery is based on location of the devices and information regarding availability of content at that location as dynamic information regarding the IoT devices.

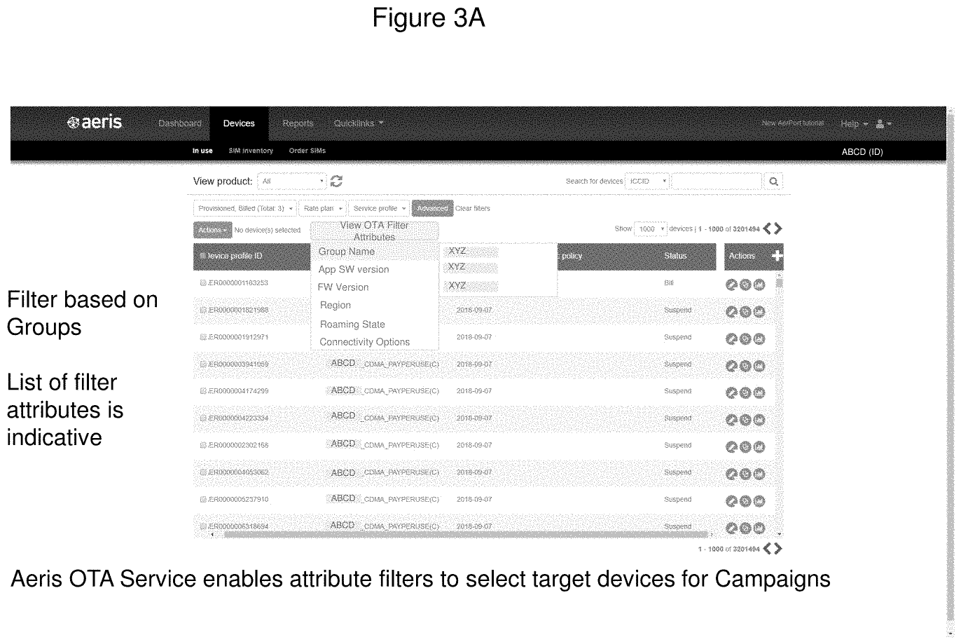

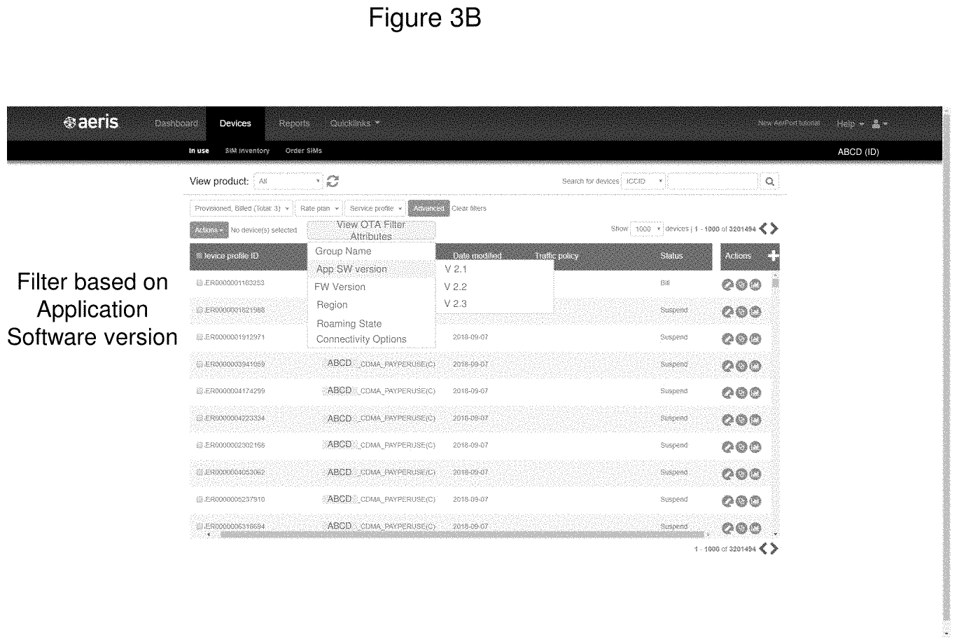

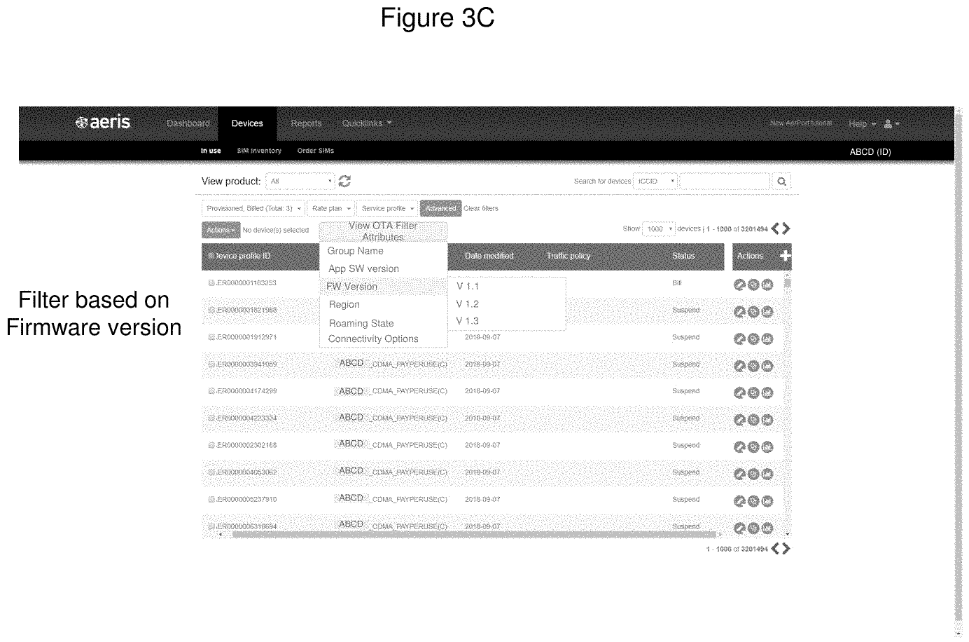

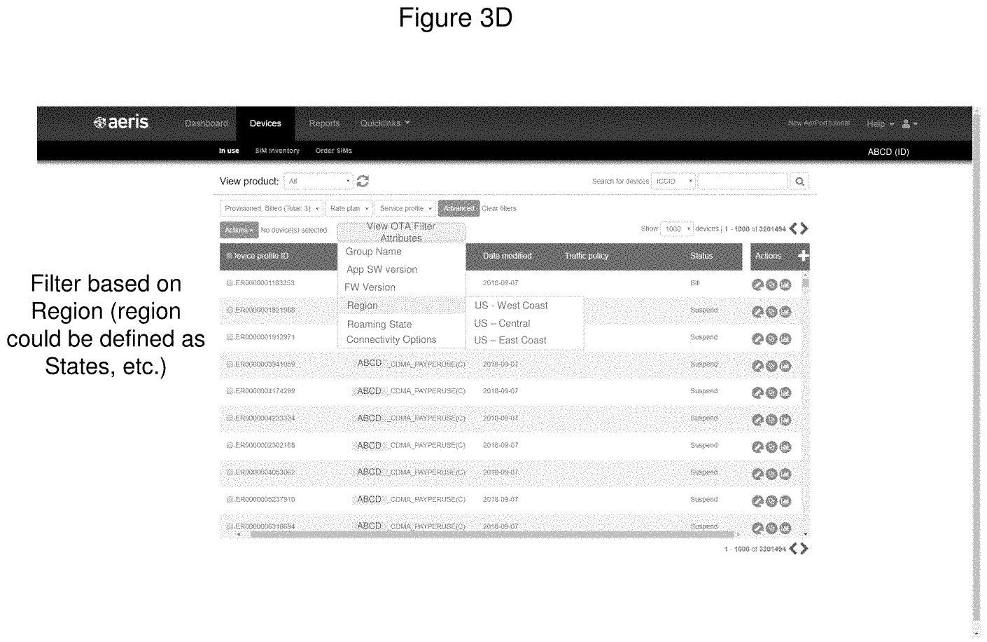

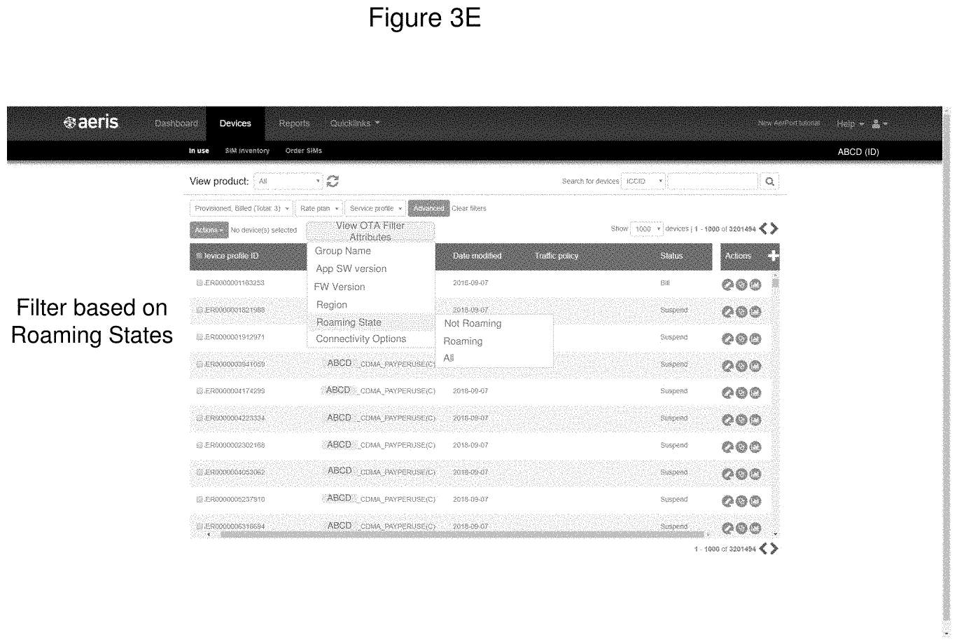

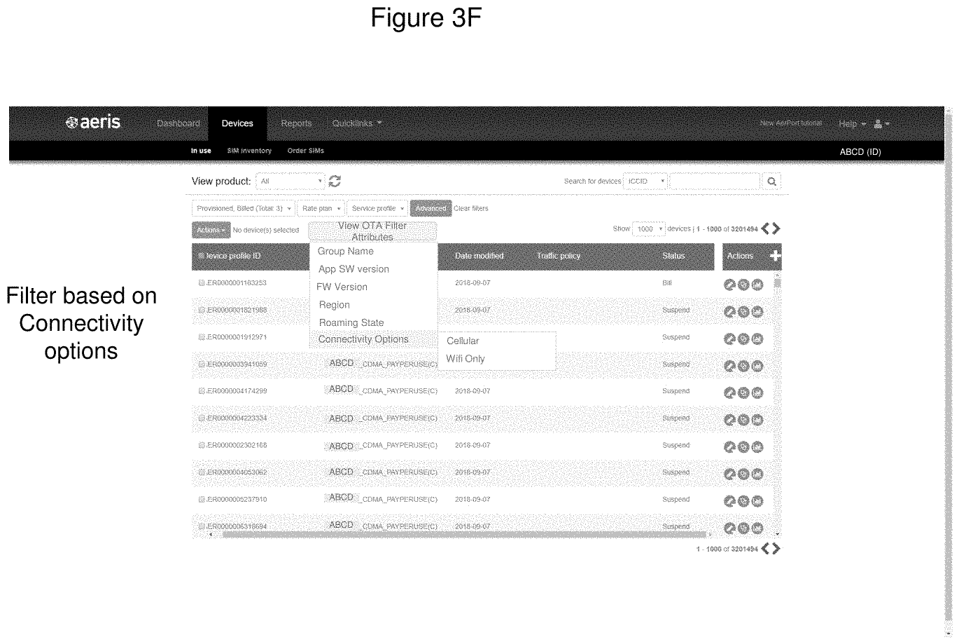

FIGS. 3A-3F illustrate example criteria used for Over The Air (OTA) delivery of firmware to devices enabled for connectivity using connectivity status of the devices in accordance with an embodiment of the present invention. For example, FIG. 3A illustrates filter based on groups, where a list of filter attributes is indicative of selection of target devices for campaigns. FIG. 3B illustrates a filter based on application software version, whereas FIG. 3C illustrates filter based on firmware version.

FIGS. 3D-3F illustrate filters based on device attributes which may be static and/or dynamic, for example, FIG. 3D illustrates a filter based on region or location of the device, e.g., geographic areas such state, country, zip code, street address or GPS information etc., FIG. 3E illustrates a filter based on roaming state of the device, and FIG. 3F illustrates a filter based on connectivity options and/or connectivity status of the device.

A person skilled in the art may understand that although a number of examples of filters and/or attributes for creating groups are provided herein, various other attributes may be used for creation of groups based on various attributes.

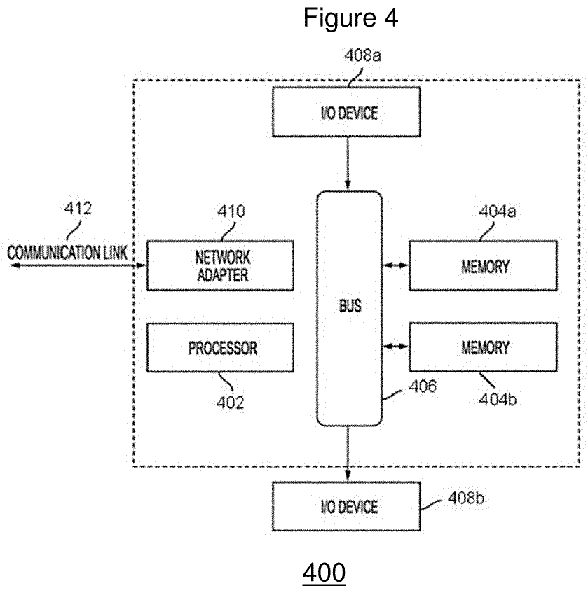

FIG. 4 illustrates a data processing system 400 suitable for storing the computer program product and/or executing program code in accordance with an embodiment of the present invention. The data processing system 400 includes a processor 402 coupled to memory elements 404a-b through a system bus 406. In an embodiment, the data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to the data processing system 400. I/O devices 408a-b may be coupled to the data processing system 400 directly or indirectly through intervening I/O controllers (not shown).

In FIG. 4, a network adapter 410 is coupled to the data processing system 402 to enable data processing system 402 to become coupled to other data processing systems or remote printers or storage devices through communication link 412. Communication link 412 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include digital versatile disk (DVD), compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, terminal, remote device, wireless asset, etc. are intended to be inclusive, interchangeable, and/or synonymous with one another and other similar communication-based equipment for purposes of the present invention though one will recognize that functionally each may have unique characteristics, functions and/or operations which may be specific to its individual capabilities and/or deployment.

Similarly, it is envisioned by the present invention that the term communications network includes communications across a network (such as that of a M2M but not limited thereto) using one or more communication architectures, methods, and networks, including but not limited to: Code Division Multiple Access (CDMA), Global System for Mobile Communications (GSM) (“GSM” is a trademark of the GSM Association), Universal Mobile Telecommunications System (UMTS), Long Term Evolution (LTE), fourth generation cellular systems (4G) LTE, 5G, wireless local area network (WLAN), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for Over The Air delivery of firmware to one or more devices enabled for connectivity comprises:
receiving static device information for the one or more devices;
receiving dynamic device information for the one or more devices;
dynamically grouping the one or more devices based on the static device information, the dynamic device information or the combination thereof; and
dynamically scheduling Over The Air delivery of firmware using the grouping to the one or more devices enabled for connectivity.

2. The method of claim 1, wherein the static device information includes one or more of: device identifier, device technology capability including peer to peer communication, make and model of the device and location of the device.

3. The method of claim 1, wherein the dynamic device information includes one or more of: connectivity status of the device, whether the device is roaming or using a home network, availability of Wi-Fi connectivity to the device, availability of cellular connectivity to the device, availability of bandwidth to the device based on time of the day, availability of bandwidth to the device based on a shared network resource, cost of operation based on time of the day, billing state of the device, location of the device based on network, subscription management awareness of the device, Quality of Service (QoS), network congestion awareness, Data session awareness, geographical location of the devices, availability of network resources at the geographical location of the devices, number of other devices at the geographical location, network status at the location of the devices and availability of peers with capability to download OTA content via peer to peer technology.

4. The method of claim 1, further including receiving network status information and dynamically grouping the one or more devices based on the static device information, the dynamic device information and network status information.

5. The method of claim 4, wherein the network status information includes number of online devices, number of roaming devices, bandwidth available, number of devices connected to a specific network element, utilization of network resources.

6. The method of claim 1, wherein the Over The Air delivery of firmware to one or more devices enabled for connectivity further comprises using an agent to accomplish the delivery.

7. The method of claim 1, wherein the Over The Air delivery of firmware to one or more devices enabled for connectivity further comprises agentless delivery.

8. The method of claim 1, wherein the Over The Air delivery of firmware to one or more devices enabled for connectivity further comprises using machine learning to identify OTA window for each device.

9. The method of claim 1, wherein the Over The Air delivery of firmware to one or more devices enabled for connectivity further comprises using a central location or other nearby compatible peers using peer to peer technology for the delivery of the firmware.

10. The method of claim 1, wherein the Over The Air delivery of firmware to one or more devices enabled for connectivity further comprises providing a user friendly interface for an OTA administrator for presenting information regarding the Over The Air delivery of firmware to one or more devices enabled for connectivity.

11. A system for Over The Air delivery of firmware to one or more devices enabled for connectivity comprises:
One or more devices enabled for connectivity;
an IoT platform for establishing an inventory of devices enabled for connectivity,
an OTA platform configured to:
receive static device information for the one or more devices;
receive dynamic device information for the one or more devices;
dynamically group the one or more devices based on the static device information, the dynamic device information or the combination thereof; and
dynamically schedule Over The Air delivery of firmware using the grouping to the one or more devices enabled for connectivity.

12. The system of claim 11, wherein the static device information includes one or more of: device identifier, device technology capability including peer to peer communication, make and model of the device and location of the device.

13. The system of claim 11, wherein the dynamic device information includes one or more of: connectivity status of the device, whether the device is roaming or using a home network, availability of Wi-Fi connectivity to the device, availability of cellular connectivity to the device, availability of bandwidth to the device based on time of the day, availability of bandwidth to the device based on a shared network resource, cost of operation based on time of the day, billing state of the device, location of the device based on network, subscription management awareness of the device, location of the device, Quality of Service (QoS), Data session awareness, geographical location of the devices, availability of network resources at the geographical location of the devices, number of other devices at the geographical location, network status at the location of the devices and availability of peers with capability to download OTA content via peer to peer technology.

14. The system of claim 11, wherein the OTA platform is further configured to receive network status information and dynamically group the one or more devices based on the static device information, the dynamic device information, network status information.

15. The system of claim 14, wherein the network status information includes number of online devices, number of roaming devices, bandwidth available, number of devices connected to a specific network element, utilization of network resources.

16. The system of claim 11, wherein the system for Over The Air delivery of firmware to one or more devices enabled for connectivity further comprises an agent to accomplish the delivery.

17. The system of claim 11, wherein the system for Over The Air delivery of firmware to one or more devices enabled for connectivity is agentless.

18. The system of claim 11, wherein the system for Over The Air delivery of firmware to one or more devices enabled for connectivity further comprises a machine learning module to identify OTA window for each device.

19. The system of claim 11, wherein the system for Over The Air delivery of firmware to one or more devices enabled for connectivity further uses a central location or other nearby compatible peers using peer to peer technology for the delivery of the firmware.

20. The system of claim 11, wherein the system for Over The Air delivery of firmware to one or more devices enabled for connectivity further provides a user friendly interface for an OTA administrator for presenting information regarding the Over The Air delivery of firmware to one or more devices enabled for connectivity.

21. A computer program product stored on a non-transitory computer readable medium for Over The Air delivery of firmware to one or more devices enabled for connectivity, comprising computer readable instructions for causing a computer to control an execution of an application for secure authentication of IoT devices comprising:
receiving static device information for the one or more devices;
receiving dynamic device information for the one or more devices;
dynamically grouping the one or more devices based on the static device information, the dynamic device information or the combination thereof; and
dynamically scheduling Over The Air delivery of firmware using the grouping to the one or more devices enabled for connectivity.

22. The computer program product of claim 21, wherein the static device information includes one or more of: device identifier, device technology capability including peer to peer communication, and make and model of the device.

23. The computer program product of claim 21, wherein the dynamic device information includes one or more of: connectivity status of the device, whether the device is roaming or using a home network, availability of Wi-Fi connectivity to the device, availability of cellular connectivity to the device, availability of bandwidth to the device based on time of the day, availability of bandwidth to the device based on a shared network resource, cost of operation based on time of the day, billing state of the device, location of the device based on network, subscription management awareness of the device, location of the device, Quality of Service (QoS), Data session awareness, geographical location of the devices, availability of network resources at the geographical location of the devices, number of other devices at the geographical location, network status at the location of the devices and availability of peers with capability to download OTA content via peer to peer technology.

24. The computer program product of claim 21, further including receiving network status information and dynamically grouping the one or more devices based on the static device information, the dynamic device information and network status information.

25. The computer program product of claim 24, wherein the network status information includes number of online devices, number of roaming devices, bandwidth available, number of devices connected to a specific network element, utilization of network resources.

26. The computer program product of claim 21, wherein the Over The Air delivery of firmware to one or more devices enabled for connectivity further comprises using an agent to accomplish the delivery.

27. The computer program product of claim 21, wherein the Over The Air delivery of firmware to one or more devices enabled for connectivity further comprises agentless delivery.

28. The computer program product of claim 21, wherein the Over The Air delivery of firmware to one or more devices enabled for connectivity further comprises using machine learning to identify OTA window for each device.

29. The computer program product of claim 21, wherein the Over The Air delivery of firmware to one or more devices enabled for connectivity further comprises using a central location or other nearby compatible peers using peer to peer technology for the delivery of the firmware.

30. The computer program product of claim 21, wherein the Over The Air delivery of firmware to one or more devices enabled for connectivity further comprises providing a user friendly interface for an OTA administrator for presenting information regarding the Over The Air delivery of firmware to one or more devices enabled for connectivity.
